(19) United States
(12) Patent Application Publication
(10) Pub. No.: US 2008/0315556 A1
(43) Pub. Date: Dec. 25, 2008

(54) TRACTOR HITCH ATTACHMENT CONNECTOR

(76) Inventor: John MIKULAS, Troutville, VA (US)

Correspondence Address: LATIMER, MAYBERRY & MATTHEWS IP LAW, LLP, 13873 PARK CENTER ROAD, SUITE 106, HERNDON, VA, 20171, US

(21) Appl. No.: 11/767,191

(22) Filed: Jun. 22, 2007

(51) Int. Cl. A01B 59/043; A01B 59/06

(52) U.S. Cl. 280/416.2; 172/439

(57) ABSTRACT

The present invention provides an apparatus and methods for connecting an attachment to a hitch system of a vehicle. The apparatus comprises means for connecting the apparatus to a hitch system and means for connecting the apparatus to an attachment, such as a plow or scraper. The present invention allows the attachment to be extended behind, offset to, or pivoted relative to the vehicle. In addition, the present invention allows multiple attachments to be connected to a vehicle by way of its hitch system.

### BACKGROUND OF THE INVENTION

1. Field of the Invention

The present invention relates to the field of industrial motor vehicles and attachments for the motor vehicle. More specifically, the present invention pertains to a connection apparatus between the motor vehicle and an attachment.

2. Description of Related Art

Industrial motor vehicles usually require an attach system when pulling attachments or implements. For example, a three point hitch system may be used to attach a plow to a tractor. Another, but less common, attachment system is the loader quick attach system that functions similarly to the three point hitch system. The implement may be connected directly to the three point hitch system or by a “quick connect” apparatus.

The three point hitch system was originally developed as a way to connect and lift attachments to a tractor. Most early applications were strictly for farming operations, such as plowing, mowing, and cultivating. As the versatility of the system was recognized, other uses were developed, such as mowing, grading, lifting, and transporting. Gradually, the use of the tractor implements evolved away from strictly farming to other applications, such as landscaping, grounds maintenance, and other chore related activities.

Also over time, the three point hitch system has been standardized to four sizes (CAT 0, 1, 2, 3) related to the size, horsepower and weight of the tractor. This standardized system has been adopted by almost all tractor manufacturers. Although the system has become standardized, it has only undergone minor changes since its inception. The system is based on three mounting points for the implement. Two steel or cast lift arms extend rearward, provide the lift and are the pull-point for the implement. The third mounting point is the top link. It extends from a top middle position at the rear of the tractor and adjusts the angle and level of the implement. Because of the fixed location of the two lower arms, the three point hitch is designed to only connect implements directly behind the motor vehicle. This limits the implement function to the area directly behind the motor vehicle. If an attachment or implement is narrower than the vehicle it is attached to, the implement cannot function in the area covered by the entire path of the vehicle. Some functions, such as grading, snow removal, and material handling need to be accomplished in areas other than the area directly behind the vehicle.

In some cases, attachments are available that can cover the area behind or even to the side of the motor vehicle, but they are available at a much greater cost than the attachment that simply functions directly behind the vehicle. For example, a scraper blade is available with a more expensive off-settable blade. In other cases, such as the box blade, the attachment is designed to only function directly centered behind the vehicle. A box blade can only function with its blade at a 90 degree angle to the direction of travel of the vehicle because of the angle with which it is attached to the three point hitch.

There are other drawbacks to the current systems. For example, the three point hitch is designed to lift attachments and therefore usually does not have down pressure that is capable of transferring the weight of the vehicle to the attachment. Extra weight is desired on many attachments to enhance performance of the attachment. Also, the three point hitch can only accommodate one attachment, whereas in certain cases, the user may desire to attach more than one implement to the vehicle.

To modify the three point hitch, U.S. patent application publication No. 2006/0288681 describes an offset hitch apparatus with two arms and an implement attachment frame with wheels to allow offset towing. However, this system requires additional wheels, which require more maintenance and are cumbersome.

While many solutions to needs in the art have been developed, a low cost apparatus that allows implements to be connected to a motor vehicle such that the attachment can function in areas that are not just directly behind the vehicle is still needed. Further, an apparatus that allows additional weight to be added to the attachment to improve performance is desirable. Likewise, an apparatus that can accommodate more than one attachment is needed in the art.

### SUMMARY OF THE INVENTION

The present invention addresses needs in the art by providing an apparatus that can be connected to a conventional three point hitch system, a “quick connect” system, or an attachment system that functions similarly to a three point hitch system. The apparatus of the present invention, when in use, is also connected to a desired attachment or implement, thereby allowing the implement or attachment to function at angles and locations not afforded by the three point hitch or similar system alone.

In general, the invention provides an apparatus that connects an implement or attachment for performing tasks (e.g., a plow) to a motorized vehicle (e.g., a tractor) having a hitch or other means for accommodating an implement or attachment. The apparatus, when attached to the hitch, provides a system for connecting attachments to the motorized vehicle, where the system provides improved or additional features as compared to the hitch alone. In particular, the apparatus of the invention allows for the placement of the attachments in different positions relative to the motor vehicle, such as: at an angle to the vehicle, to the side of the vehicle, and at an extended distance behind the vehicle.

In a first aspect, the apparatus of the invention is referred to herein as a “Swinghitch”, a universal adapter that connects to a three point hitch and also connects to an attachment. In essence, the Swinghitch acts as a linkage between the three point hitch (and thus the tractor or other vehicle to which the hitch is attached) and an attachment. Because of its pivot and angle holding mechanisms, the Swinghitch allows the attachment to be connected to a motor vehicle at an angle. Thus, in contrast to use of a three point hitch alone, the combination of three point hitch and Swinghitch allows the attachment to be rotated to an operator-selected angle normal to the front-rear axis of the vehicle. The angling of the Swinghitch causes the attachment to be offset to one side as well as rotated normal to the axis of the tractor, thereby offering two enhanced degrees of freedom in the use of the attachment. This allows the attachment to be used at angles and locations not allowed by a three point hitch without the adapter. This improvement in the use of the three point hitch allows the attachment to be located farther to one side and also farther behind the vehicle, and allows additional weight to be added to the attachment, all thereby enhancing the function of the attachment.

In another aspect, the apparatus of the invention is referred to as a “Shifthitch”. The Shifthitch acts as a linkage between the vehicle's hitch and an attachment by acting as a universal adapter in which the Shifthitch allows for the attachment to be connected to the vehicle in such a way that it is offset to the vehicle. This allows the attachment to be located at an operator-selected offset to the side to side axis of the vehicle, and therefore offers an enhanced degree of freedom of the use of the attachment. This improvement allows the attachment to be located farther to one side of the vehicle and also farther behind the vehicle, and allows additional weight to be added to the attachment.

In an additional aspect, the apparatus of the invention is referred to as a “Dualhitch”, which again is a universal adapter that also connects a hitch, such as a three point hitch, to an attachment. In this case, the Dualhitch allows at least two attachments to be connected to the vehicle at the same time. In general, the Dualhitch widens the connection zone of the vehicle's hitch to a width that can accommodate two or more attachments, rather than the single attachment that can normally be connected to a hitch.

In yet another aspect, the apparatus of the invention is referred to as an “Extendhitch”. In this embodiment, the apparatus is a universal adaptor that adds an extension between the vehicle and the attachment to be connected to it. This allows the attachment to be located at an operator-selected offset to the front to rear axis of the vehicle. The Extendhitch thus allows the attachment to be located farther to the rear of the vehicle and allows additional weight to be added to the attachment. Even more additional weight can be added to the attachment through the use of weight blocks.

In another aspect, the apparatus of the invention comprises a combination of at least two of the universal adapters discussed in the previous aspects. In this case, two or more of the adapters are connected together, and one or more attachments appropriately connected to the adaptors. This multi-adaptor system allows various combinations of the adapters to be employed, and the various advantages of the adapters to be realized. The combination can be comprised of the same or different kinds of adapters.

In yet a further aspect, the present invention provides methods of employing the universal adapters described in the invention. In general, the methods comprise providing one or more of the adapters of the invention, connecting at least one adapter to a vehicle via a three point hitch or similar system, connecting at least one attachment to the adaptor, and using at least one attachment for its function.

### BRIEF DESCRIPTION OF THE DRAWINGS

The accompanying drawings, which constitute a part of this specification, illustrate several embodiments of the invention and, together with the written description, serve to explain various principles of the invention. It is to be understood that the drawings are not to be construed as a limitation on the scope or content of the invention.

FIG. 1 depicts a scraper blade attached to the three point hitch of a tractor according to a standard configuration. FIG. 1A depicts a top view of the tractor, three point hitch, and blade. FIG. 1B depicts a perspective view of the tractor, hitch, and blade.

FIG. 2 depicts a Swinghitch connected to the three point hitch of a tractor. FIG. 2A shows a top view of the hitch and tractor. FIG. 2B shows a side view of the hitch and tractor. FIG. 2C shows a perspective view of the hitch and tractor.

FIG. 3 depicts a Swinghitch connected to the three point hitch of a tractor and also connected to a scraper blade.

FIG. 4 depicts the same embodiment as FIG. 3 and shows the area that the scraper blade covers when the Swinghitch is not angled. FIG. 4A shows a top view. FIG. 4B shows a perspective view.

FIG. 5 depicts the same embodiment as FIG. 3 and shows the area that the scraper blade covers when the Swinghitch is angled. FIG. 5A shows a perspective view from the top and front. FIG. 5B shows a top view. FIG. 5C shows a perspective view from the top and rear.

FIG. 6 shows an embodiment of the Swinghitch and its component parts. FIG. 6A depicts a side view, showing certain elements of the hitch. FIG. 6B shows a perspective view from the top, front, and side of the hitch. FIG. 6C shows a perspective view of the hitch from the top, back, and side of the hitch. FIG. 6D shows a rear view of the hitch. FIG. 6E shows a top view of the hitch. FIG. 6F shows a detailed perspective view of the Swinghitch in a substantially assembled state. FIG. 6G shows the Swinghitch of FIG. 6A in assembled form. FIG. 6H shows the Swinghitch of FIG. 6B in assembled form. FIG. 6I shows the Swinghitch of FIG. 6C in assembled form. FIG. 6J shows the Swinghitch of FIG. 6E in assembled form. FIG. 6K shows an embodiment of the Swinghitch in which the hitch is angled.

FIG. 7 depicts one embodiment of a Shifthitch according to the invention. FIG. 7A shows a top view of the hitch. FIG. 7B shows a perspective view from the front and top of the hitch. FIG. 7C shows a side view of the hitch. FIG. 7D shows a rear view of the hitch. FIG. 7E shows a perspective view of the hitch from the top and rear.

FIG. 8 depicts one embodiment of a Dualhitch according to the invention. FIG. 8A shows a top view of the dualhitch. FIG. 8B shows a perspective view from the front and side of the hitch. FIG. 8C shows a side view of the hitch. FIG. 8D shows a rear view of the hitch. FIG. 8E shows a perspective view of the hitch from the top, side, and rear of the hitch.

FIG. 9 depicts an embodiment of an Extendhitch. FIG. 9A depicts a side view of the hitch. FIG. 9B depicts a perspective view of the hitch from the front, top, and side of the hitch. FIG. 9C depicts a top view of the hitch. FIG. 9D depicts a perspective view of the hitch from the rear, side, and top of the hitch.

FIG. 10 depicts a combination of a Shifthitch, a Dualhitch, and two Swinghitch adapters. FIG. 10A depicts the combination from a perspective view from the front, top, and side. FIG. 10B depicts the combination from a perspective view from the back, top, and side. FIG. 10C depicts the combination from a top view. FIG. 10D depicts the combination from the side. FIG. 10E depicts a detailed perspective view showing in detail various connections.

### DETAILED DESCRIPTION OF VARIOUS EMBODIMENTS OF THE INVENTION

Reference will now be made in detail to various exemplary embodiments of the invention, some of which are depicted in the figures. The following description is provided to give details on certain embodiments, features, and details of the invention, and should not be understood as a limitation on the full scope of the invention.

Broadly speaking, the present invention provides a universal adapter between a hitch system of a motor vehicle and an attachment. This adapter allows the attachment to be used in ways not provided by the hitch itself, such as at an angle to the motor vehicle, farther back from the motor vehicle, or farther to the side of the motor vehicle. In embodiments, it also allows more than the one attachment to be connected to the motor vehicle. In addition, combinations of the above adapters can be used simultaneously on one vehicle. The term “universal adapter” refers to an apparatus of the present invention that can be connected to any three hitch point or similar system of a vehicle and can also connect simultaneously to virtually any attachment that is meant for a three point hitch or similar system.

The apparatus of the present invention can be connected to any motor vehicle that uses an attachment connection system. These vehicles include cars, trucks, all terrain vehicles (ATVs), trailers, industrial vehicles such as snowplows, and agricultural vehicles such as mowers and tractors. This invention is especially applicable to any kind of tractor, whether it is used for agricultural or industrial means, and pertains to front end loaders, skid steer tractors, as well as conventional tractors known and used in farming, landscaping, or other similar activities. Various hitches and connections are amenable to the present invention. However, due to the widespread use of a standard three point hitch, the present disclosure focuses on such a hitch.

The apparatus can be used for power take-off or non-power-take off applications. Any kind of power take-off will work with the universal adapter. This includes transmission, live (two-stage clutch) or independent power take-off types. Because of the relatively small size of the adapters, attachments are still able to connect to a power take-off and draw energy from the vehicle's engine. The attachments can be powered hydraulically, electrically, or using air power. The attachments can also be self-powered, in the case of attachments that have their own engine. Of course, non-power-take off applications, which do not require connection to an engine will still work with any of the universal adapters of the invention.

The apparatus can be used with any attachment system that is similar to a three point hitch system. This includes all categories of the conventional three hitch system (categories 0, 1, 2, and 3) as well as to other tractor hitch systems, such as a loader quick attach system. For ease of reference, the attachment system herein will be referred to as a three point hitch system. However, any system that is similar to the three hitch system can be employed with this invention. The apparatus can be connected to a rear mounted three point hitch system as well as to a front or side mounted system. The apparatus can also be employed with quick connect or quick hitch systems that are added on to a three point hitch to facilitate easy connecting and decoupling of attachments. The quick connect systems can connect to an attachment and therefore, can also connect to the apparatus of the present invention.

The attachments (also termed implements or tools) used to connect to the apparatus of the present invention include virtually any three point hitch attachment available. These include, but are not limited to, scraper blades, box blades, boom poles, carryalls, mowers, plows, rakes, cultivators etc. One of the advantages of the invention is that the attachment itself does not have to be modified, thereby allowing flexibility in terms of the number of unmodified attachments that can be used with the invention.

The apparatus of the invention can be connected to the three point hitch using holes provided by the hitch and means to go through the holes provided by the adapter. Connection from the adapter to the attachment can occur using holes provided by the adapter and means to go through the holes provided by the attachment. The means to go through the holes may be posts, nails, screws, hitch pins, or any other hardware that will connect the adapter to the hitch and the attachment. If hitch pins are used, preferably cross pins are placed at the end of the hitch pins to secure the hitch pins. The apparatus and connection hardware may be comprised of one or more metals (e.g., iron, steel, aluminum, copper), wood, plastic, or any other material that will allow the apparatus to function. Alternatively, to connect to the three point hitch, any or all of the attachment connectors can be connected by other systems such as the various quickhitch connection systems available. In embodiments, the universal adaptor has both holes and means to go through other holes. It can be seen that because the universal adapter has both holes and means to go through other holes, it can be connected to other adapters in a series and, in embodiments, accept multiple attachments.

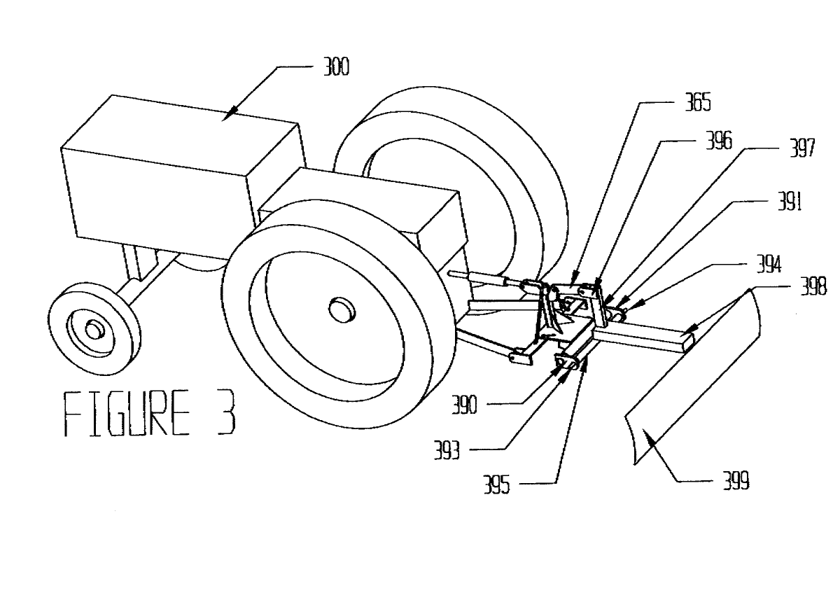

In one general aspect, the invention provides a Swinghitch that connects to a three point hitch and also connects to an attachment. This universal adapter has pivot and angle holding mechanisms, thereby allowing the attachment to be used at a selected angle normal to the front-rear axis of the vehicle or at a selected angle parallel to the front-rear axis of the vehicle. Stated in a different way, the Swinghitch can be connected directly to a three point hitch and can pivot from the point of attachment, thereby allowing the attachment to be used at a selected angle along a line parallel to the side-to-side axis of the tractor. The Swinghitch can also be connected to a three point hitch in such a way that the pivoting angle occurs along a line parallel to the front-rear axis of the vehicle. The apparatus is adaptable in that it can be provided with pre-set stops at pre-defined angles (e.g., 0°, 13°, and 26° to the left and right) or can allow for infinite angles by providing a free-moving pivoting means with a holding mechanism (e.g., hydraulic brake or locking mechanism) that can hold or lock the adaptor at a desired angle with respect to the three point hitch and vehicle. The user can manually operate the Swinghitch by turning the Swinghitch to the desired angle and locking it down, for example by way of pins (for pre-set angles) or friction locking (e.g., a screw mechanism that causes a locking means to hold the adaptor at the desired angle; see FIG. 3). The Swinghitch can be angled and held at infinite angles by an actuator such as a cylinder, lead screw actuator, or other powered or manual device. Alternatively, the user can operate the Swinghitch via a hydraulic cylinder, such as that found on the three point hitch of a vehicle. The pivot and angle holding mechanisms can be at the end of the Swinghitch closest to the vehicle or can be located at the end closest to the attachment or both.

As an example, the Swinghitch can be interposed between a three point hitch of a tractor and a grader blade, which is an attachment that can be used to level land, to move material onto a gravel road or driveway, to move unwanted material such as dirt or snow off a road, driveway, or other area, etc. The grader blade, when attached directly to the tractor by way of the three point hitch, will stay centered behind the tractor. Where the blade is narrower than the tractor, the blade cannot reach to the point of the outside of the tractor tire and therefore, cannot reach to the edge of the area being graded. In contrast, when a Swinghitch is connected between the grader blade and the tractor, the blade can be set at an angle from the tractor, and extend beyond the tires on one side of the tractor. In such a set-up, the blade now can reach the full width of the area being graded by making two passes with the tractor. By interposing the Swinghitch between the tractor and the blade, the blade is located farther away from the tractor, thereby giving the blade more effective weight. Furthermore, as a result of shifting more weight to the attachment, the Swinghitch allows increased traction and an enhancement of the attachment function. Additionally, because the attachment is located farther away from the tractor, it is easier to maneuver the attachment in tight locations or close to the edge of an embankment.

As another example, the Swinghitch can be used with a grader box, an attachment that is usually centered behind a tractor and is used to smooth a gravel road, lane, or driveway. A grader box helps smooth ripples that form on a gravel path, but used in current systems, tends to follow the ripples rather than fill them. However, when Swinghitch is connected between the grader box and the tractor, the grader box can be angled as compared to the pathway and will better fill the ripples of gravel rather than following them. Also, when rotated, the grader box will reach closer to the outer edge of the path of the tractor or other vehicle to which it is attached. As in the above example, the box will be located farther away from the tractor and will have greater effective weight, enhancing the function of the attachment.

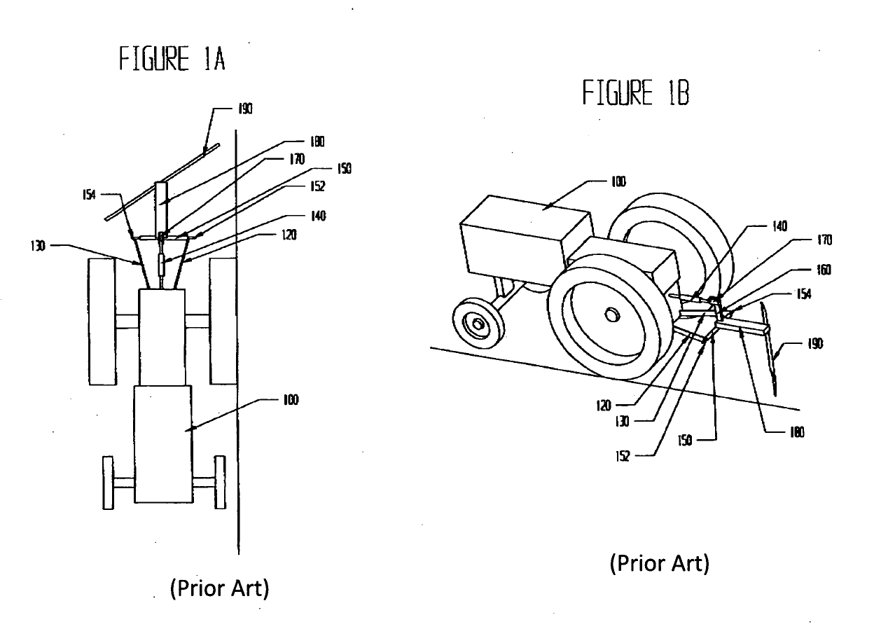

Before disclosing one embodiment of the Swinghitch in detail, a schematic diagram of the three point hitch of a tractor connected directly to an attachment will be described with reference to FIGS. 1A (top view) and 1B (combination perspective from side and top). In these figures, a scraper blade 190 is connected to a tractor 100 at the three point hitch 120, 130, and 140 of the tractor. The hitch is comprised of three moveable arms: two outer arms 120 and 130, which are controlled by a hydraulic system, and a center arm 140, which is usually not controlled by a hydraulic system. The attachment is comprised of the scraper blade 190 and attachment parts 150, 152, 154, 160, 170, and 180. The attachment is connected to the center arm 140 of the hitch at connector 170, and is connected to the outer arms 120 and 130 at pins, rods, or dowels 152 and 154 on attachment part 150. As shown in FIG. 1, the scraper blade cannot reach to the edges of the tractor tires. As should be evident, the scraper blade is locked into a single position directly behind the tractor.

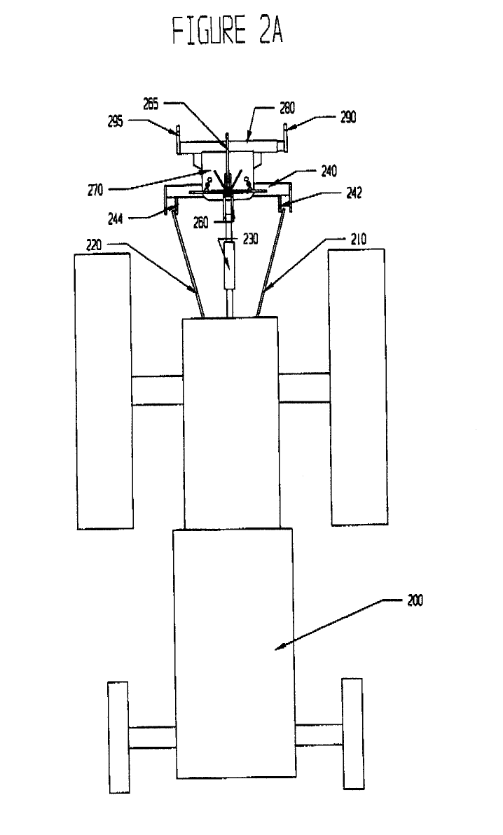

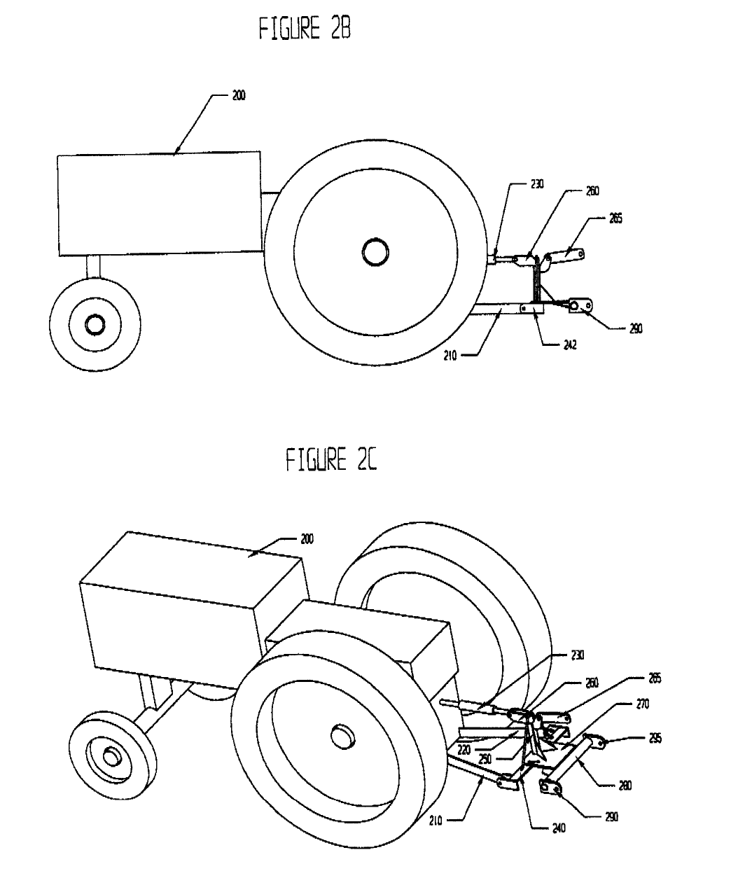

FIG. 2, Panels A-C, demonstrate an embodiment of the Swinghitch of the invention in which the Swinghitch is connected to the three point hitch of a tractor 200. Panel 2A and 2C demonstrate a top view and a combination top and side view, respectively. These views show the three point hitch of tractor 200, comprised of two outer arms 210 and 220 and a center arm 230, connected to a Swinghitch. The center arm 230 of the three point hitch is linked to connector or attachment 260 of the Swinghitch. The outer arms 210 and 220 of the three point hitch are linked to connectors 242 and 244, respectively, of the Swinghitch. Connectors 242 and 244 are attached to bracket, brace, or support 240 of the Swinghitch. Sub-assembly 250 comprises a tube, cylinder, pipe or connector (not depicted in this figure) and a pivot pin (not depicted in this figure) that allows platform 270 to pivot relative to bracket 240, as will be discussed in greater detail below. Tube, cylinder, pipe, or connector 280 attaches to connectors 290 and 295, which comprise at least one hole each. The attachment of interest can be connected to the Swinghitch at plate or connector 265 and connectors 290 and 295. Panel 2B shows a side view of the embodiment in which outer arm 210 and center arm 230 can be seen of the three point hitch. This view shows connectors 242 and 260, which attach the Swinghitch to the three point hitch. It also shows plate 265 and connector 290, which are the connection points between the attachment and the Swinghitch.

FIG. 3 show the same embodiment of the Swinghitch as shown FIG. 2 except that an attachment, specifically a scraper blade 399, is now also connected to the Swinghitch as well as the three point hitch of the tractor 300. The attachment is connected to the Swinghitch at plate 365 of the Swinghitch and connector 396 of the attachment. The attachment, comprised of connectors 396, 397, and 398, rod 395 and scraper blade 399, is also connected to the Swinghitch at connectors 390 and 391 of the Swinghitch and pins, dowels, or rods 393 and 394 found at the ends of tube, pipe, cylinder, or connector 395 of the attachment. As an example of how the rotation of the adapter can occur along the side-to-side axis of the vehicle, plate 365 can be adjustable in length or simply have more than one hole at each end. Plate 365 can also be a hydraulic cylinder or other type of manual or powered actuator.

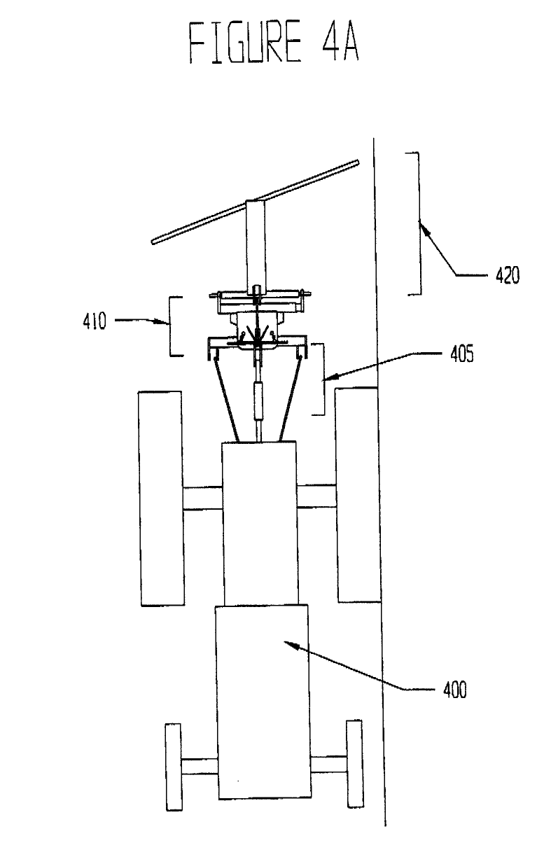

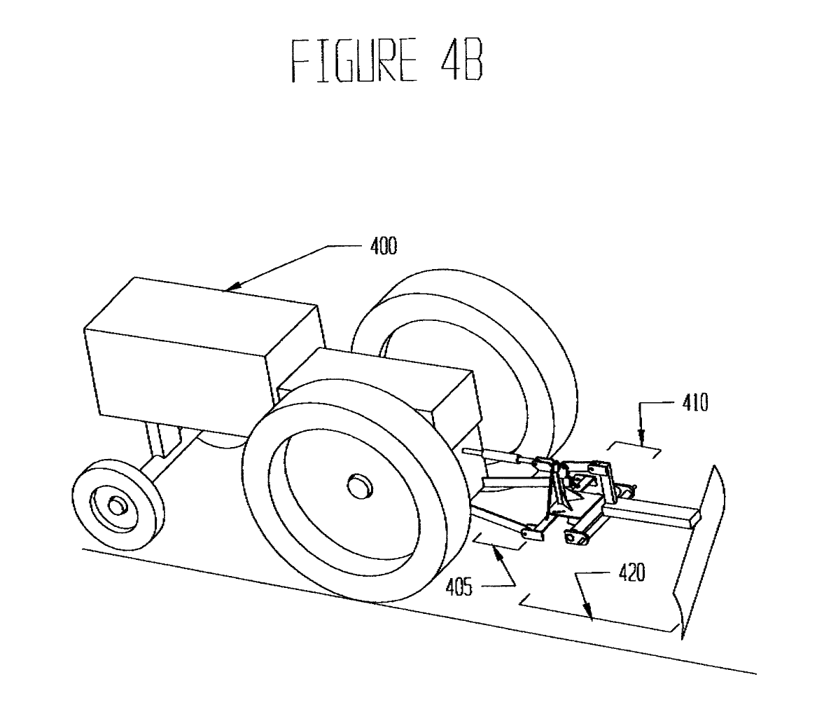

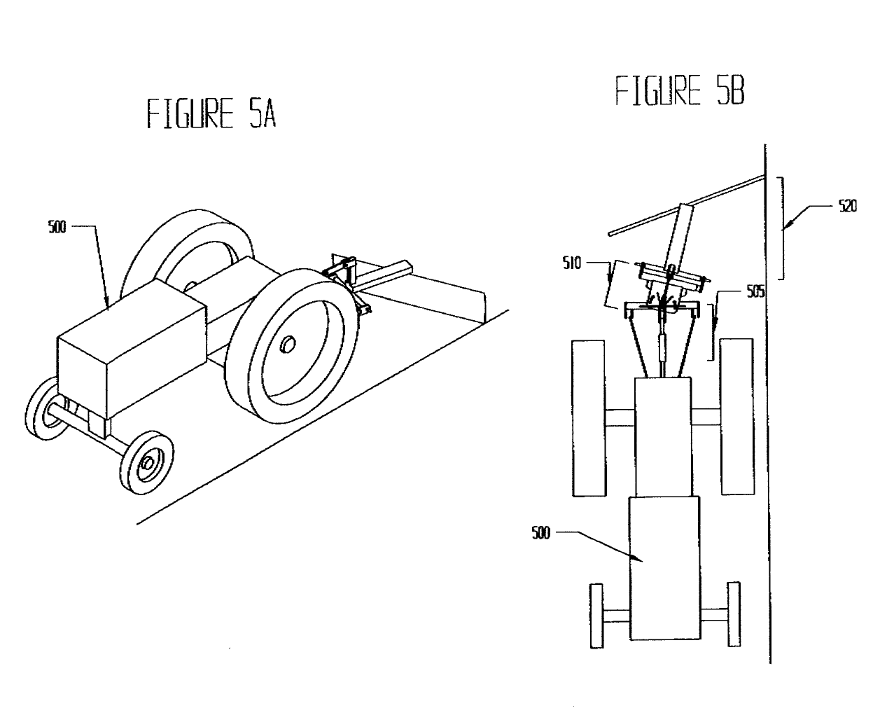

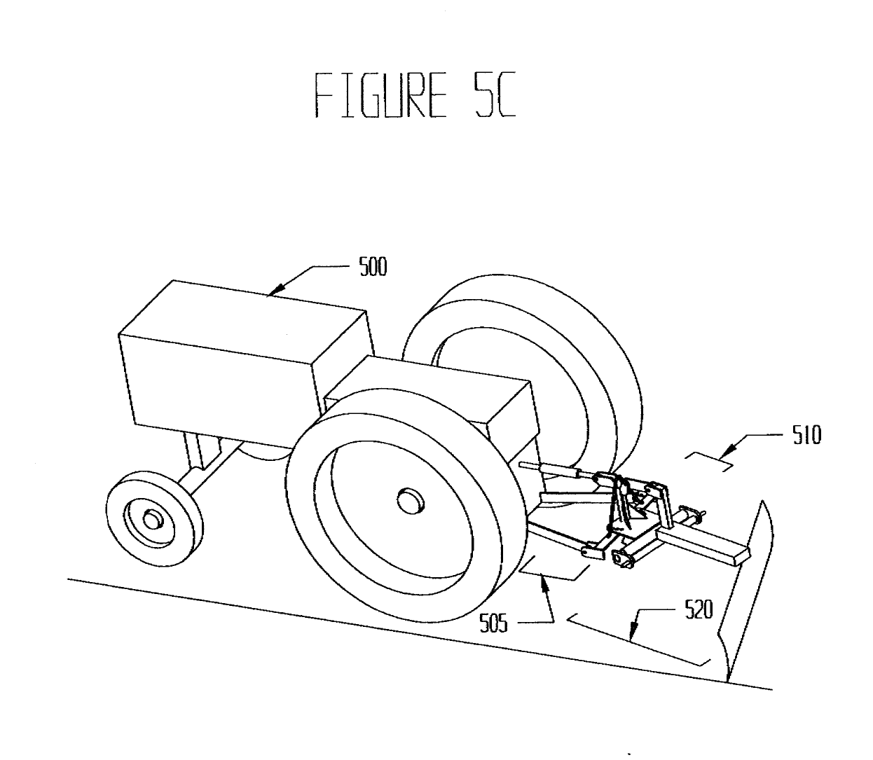

The next two figures (FIGS. 4 and 5) show the same embodiment of the Swinghitch as shown in FIG. 3. In FIG. 4, Panels A and B, the Swinghitch 410 is connected to both the three point hitch 405 of a tractor 400 and to a scraper blade attachment 420. In FIG. 5, the Swinghitch 510 is connected to both the three point hitch 505 of a tractor 500 and to a scraper blade attachment 520. However, in contrast to FIG. 4, the scraper blade 520 in FIG. 5 is set at an angle to tractor 500 by way of the Swinghitch. The panels of FIG. 4 show the path of the scraper blade when the Swinghitch is not pivoted, while the panels of FIG. 5 show the path when the Swinghitch is at an angle to the tractor. As seen in FIG. 5, Panels A-C, when the Swinghitch 510 is pivoted relative to the tractor 500, the scraper blade 520 can reach beyond the tires of the tractor.

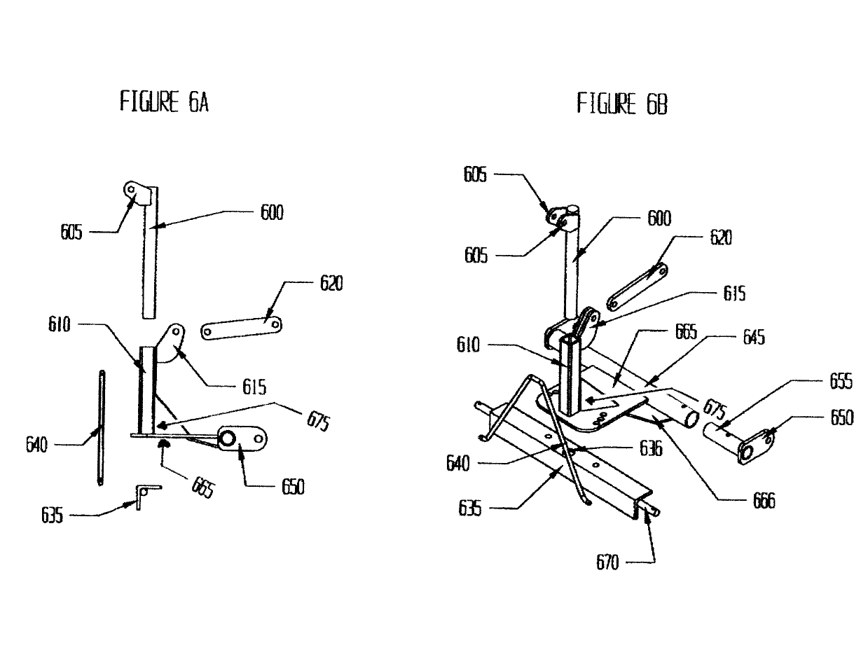

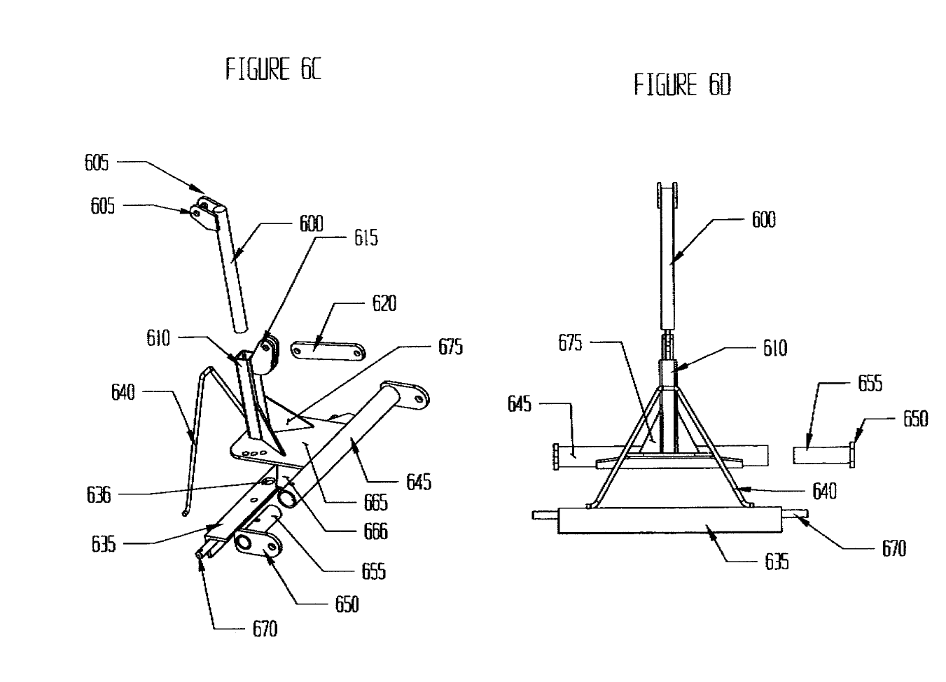

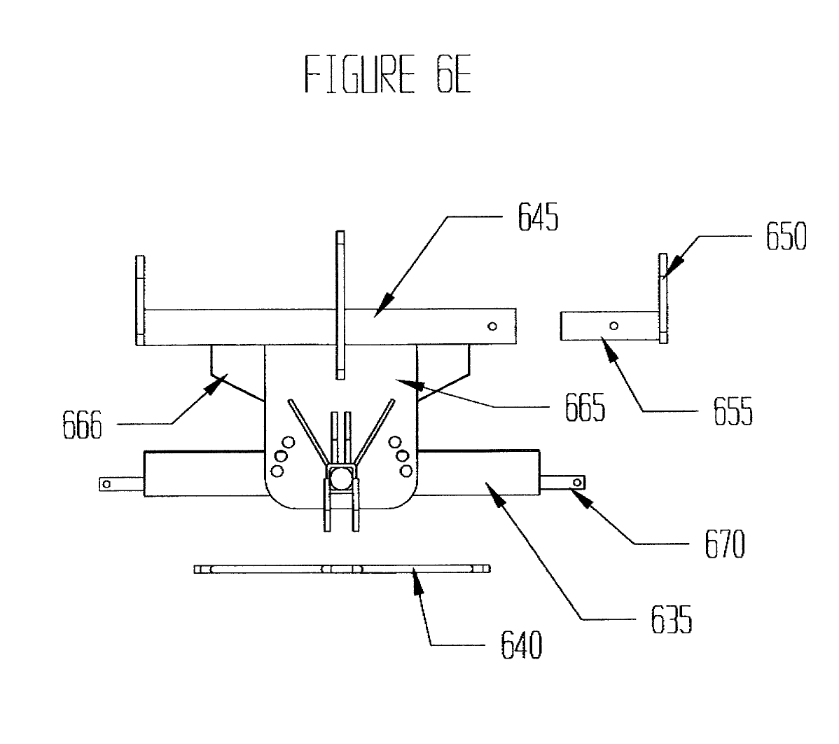

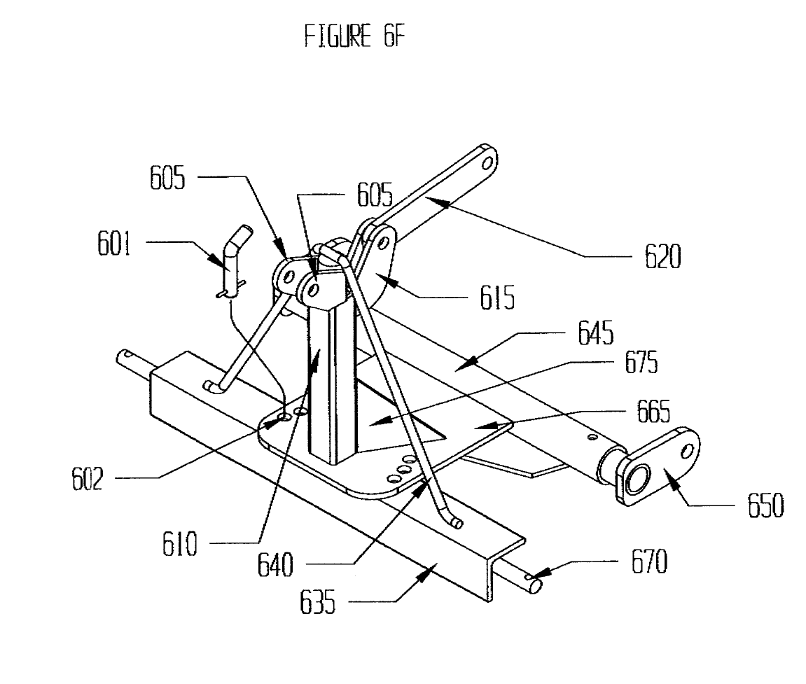

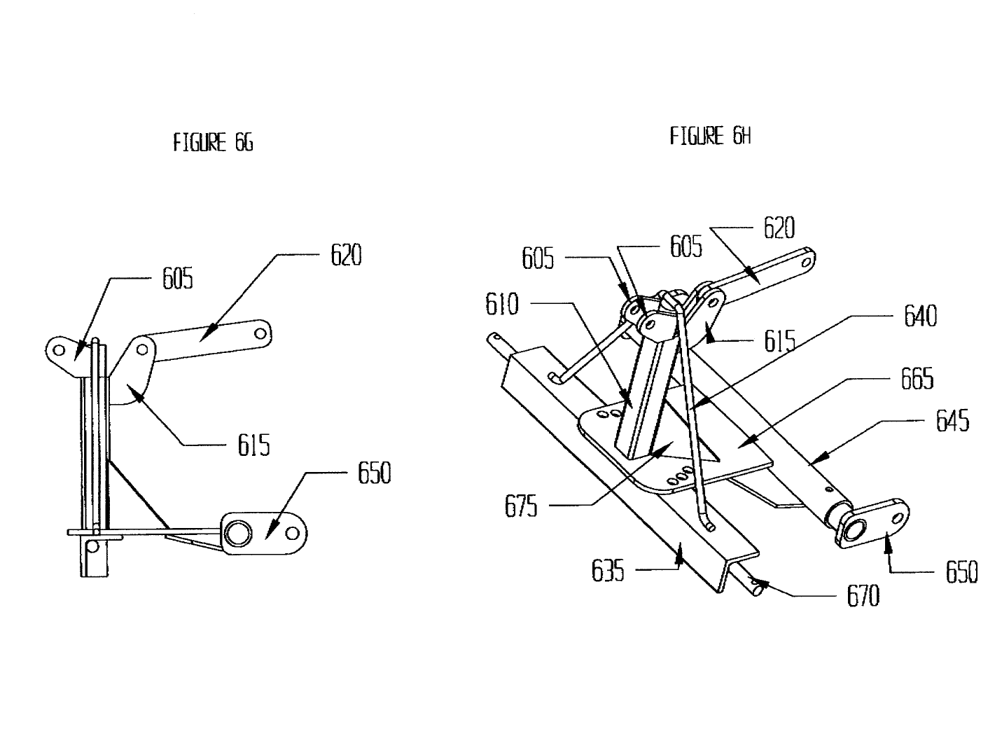

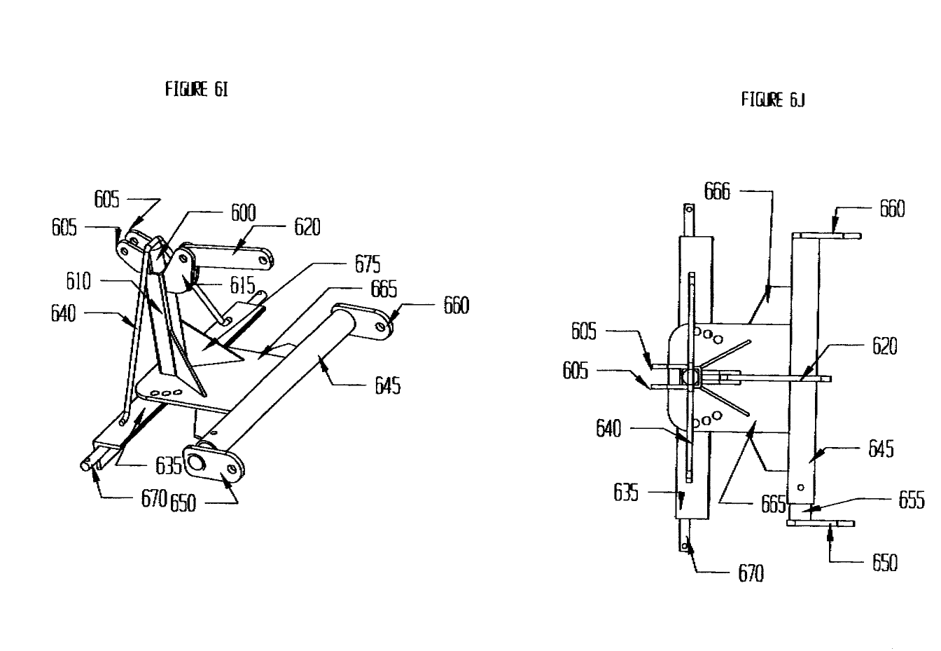

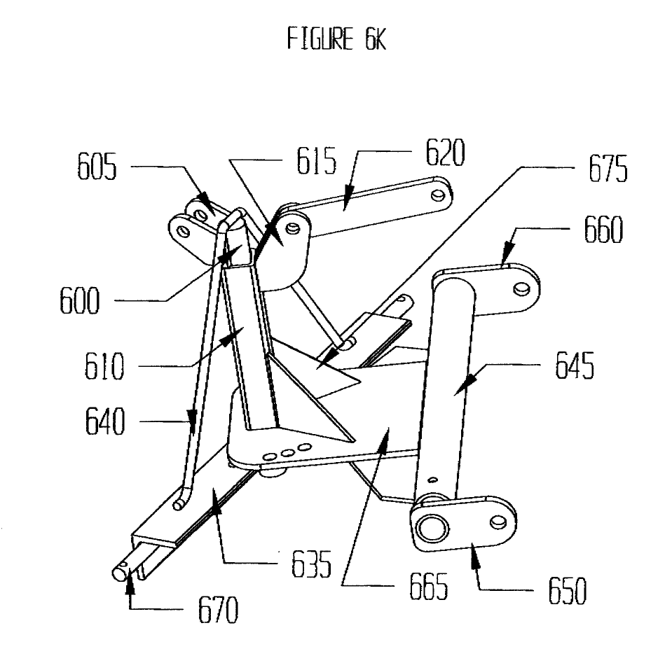

FIG. 6 depicts the Swinghitch parts of one embodiment in more detail. In FIGS. 6 A-K, parts involved in the connection of the Swinghitch to a three-point system and an attachment are shown. The various panels show the device from different angles and at different times during assembly. Taken together, the Panels provide a summary of the elements of this embodiment and a method for assembling it. In general, in this Figure and all other Figures presented herein, all elements of the device may be connected using suitable means, as known in the art. Thus, for example, elements that are designed to be permanently attached to each other may be connected by way of any suitable means, including, but not limited to, unitary production (e.g., molding as a single piece from molten metal), welding, soldering, bolting, screwing, riveting, or by any other suitable fastening means. Where parts are designed to rotate, swivel, or pivot with respect to each other, suitable rotatable connections can be used, such as a rotatable rod disposed within a tube, a bearing-guided assembly for rotation of a part against another, and the like. Further, where parts are intended for removable connection, suitable means for such connection can be uses, such as nut-and-bolt fastening, screwing, and the like.

As shown in Panel 6A, connector 605, which is a connector for attachment to the three-point hitch system, is fixedly attached (e.g., welded) to shaft or connector 600. Connector 615 is likewise fixedly attached to tube, pipe, connector, rod, or cylinder 610, and includes means for attaching to plate 620. Tube 610 is fixedly attached to platform 665, which is connected by any means (e.g., welding, unitary molding) to adaptor 650. Brace, bracket, or support 640 and bracket 635 attach to each other and/or tube 610 or platform 665. Brace 675 is fixedly attached to platform 665 and tube 610.

One way to fabricate the device can be demonstrated by Panels 6B (combination of front and side view) and 6C (combination of back and side perspective) as follows: platform 665 is welded to tube 610 and gusseted with brace, bracket, or support 675, which is also welded to platform 665 and tube 610. Tube 645 is welded to platform 665 and to tube 655. Connector 615 is welded to the top of tube 610. Gusset 666, which functions as a gusset between platform 665 and tube 645, is welded underneath platform 665 and to tube 645. Connector 650 is welded to tube 655. Dowel 670 is welded to each end of bracket, brace, or support 635. Shaft 600, which is attached to connectors 605, is placed into and through tube 610, into hole 636 in bracket 635, and then welded to bracket 635. After the parts 610, 615, 665, 675, 645, 655, and 666 are connected as described above, sub-assemblies are connected as shown in the Figure panels. For example, brace 640 is welded to both ends of bracket 635 and to the top of shaft 600. Connector 620 can also be attached by any means to connector 615.

FIG. 6D depicts a front view (a view from the tractor) of an embodiment. In this panel, shaft 600 can be placed into tube 610 to form the pivot pin sub-assembly. From this view, bracket 635 can be seen connected to dowel 670 and to brace 640. Connector 650 is welded or attached to tube 655, which can then be attached to tube 645.

A view from the top of the Swinghitch is shown in FIG. 6E. Brace 640 can be assembled onto bracket 635, which is also attached to dowel 670. Gusset 666 connects to platform 665 and to tube 645. Connector 650 is welded to tube 655 and is then attached to tube 645. FIG. 6J also shows a top view of the Swinghitch with additional parts labeled. This panel depicts connectors 605, an attachment site for the three point hitch, and plate 620, a connection site for the attachment of interest. Also labeled is part 660, which is welded to tube 645.

FIG. 6F depicts a combination front and side view of the embodiment in which platform 665 and dowel 670 are both attached to bracket 635. Connectors 605 are attached to tube 610, which is attached to platform 665. Braces or brackets 640 and 675 provide support to the sub-assembly. Connector 615 and plate 620 form one connection to the attachment of interest. Tube 645, adjoining connector 650, and a similar part on the other side of tube 645 (not seen in this view) form another connection to the attachment. As depicted in the Figures, the Swinghitch can pivot from about 0 degrees to about 30 degrees both to the right and to the left relative to bracket 635, although in other embodiments, the angle of rotation can be higher or lower. In one preferred embodiment, the Swinghitch can be locked at 0 degrees, 13 degrees, and 26 degrees on both the right and the left. FIG. 6F discloses in detail one embodiment of how the locking mechanism on the Swinghitch can function. In this case, a pin, such as hitchpin 601, is placed through a hole 602 that lines up at the selected angle. The hitchpin 601 can be restrained with a cross pin resulting in the Swinghitch locked in one position.

A side view of the Swinghitch is demonstrated on Panel 6G. In this panel, connectors 605, 615, and 650 can be seen as well as plate 620. Connector 650 and plate 620 connect to the attachment of interest and connector 605 attaches to the three-point hitch system.

Panels 6H (combination of front and side view), 6I (combination of back and side perspective with the Swinghitch not pivoted), and 6K (combination of back and side view with the Swinghitch pivoted at an angle) show similar parts of the embodiment. Platform 665 is welded to tube 610 and gusseted with brace 675, which is also welded to platform 665 and tube 610. Tube 645 is welded to platform 665 and to connectors 650 and 660 (hidden in Panel 6H). Connector 615 is welded to the top of tube 610. Dowel 670 is welded to each end of bracket 635. Shaft 600 (hidden in Panel 6H), which is attached to connectors 605, is placed into and through tube 610 and then welded to bracket 635. After the parts within each sub-assembly are connected as described above, sub-assemblies are connected as shown in the Figure panels. For example, brace 640 is welded to both ends of bracket 635 and to the top of shaft 600 (hidden in Panel 6H). Connector 620 can also be attached by any means to connector 615.

In addition to the Swinghitch configuration, the invention provides a Shifthitch apparatus, which is also a universal adapter that connects to a three point hitch and an attachment. In this case, the connection between the Shifthitch and the attachment is offset to the side of the motor vehicle. This allows the attachment to be located at an operator-selected offset to the side-to-side axis of the vehicle. The offset distance can range from about 0.5 feet to about 10 feet (15 cm to 3 meters). In a preferred embodiment, the distance is about 3 feet which is one-half of a 6 foot attachment. In one exemplary embodiment, the Shifthitch connects the three point hitch of a vehicle to a grader box. Without the Shifthitch connection, the grader box typically would not be able to reach to the edge of the vehicle tires. With the Shifthitch, the grader box is shifted to one side of the vehicle and can now grade an area farther to the side of the vehicle. This offset gives the operator of the vehicle greater versatility in grading the path behind and to the side of the vehicle. The grader box also has greater effective weight so it allows better digging during use.

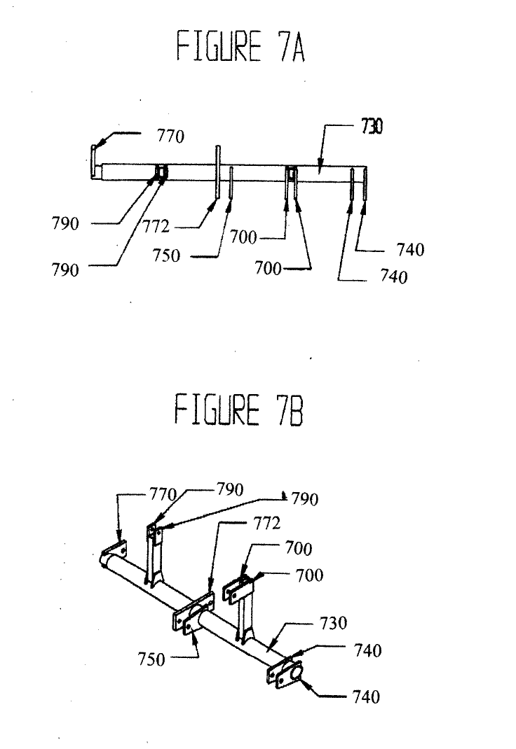

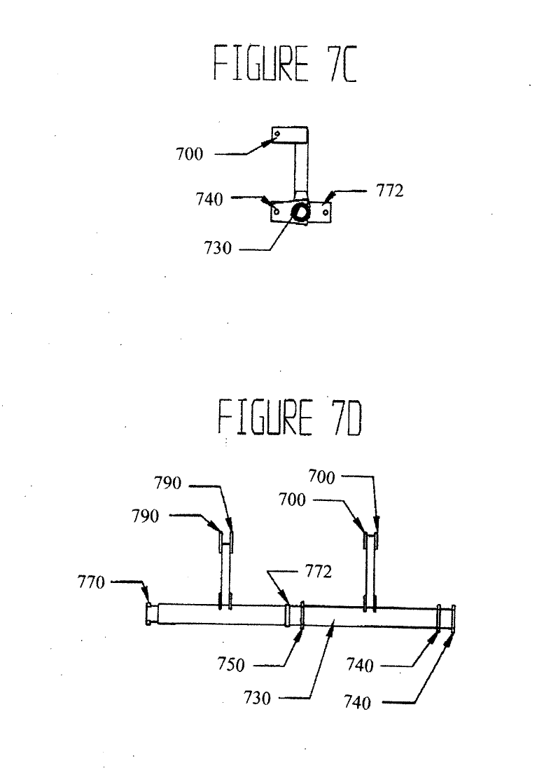

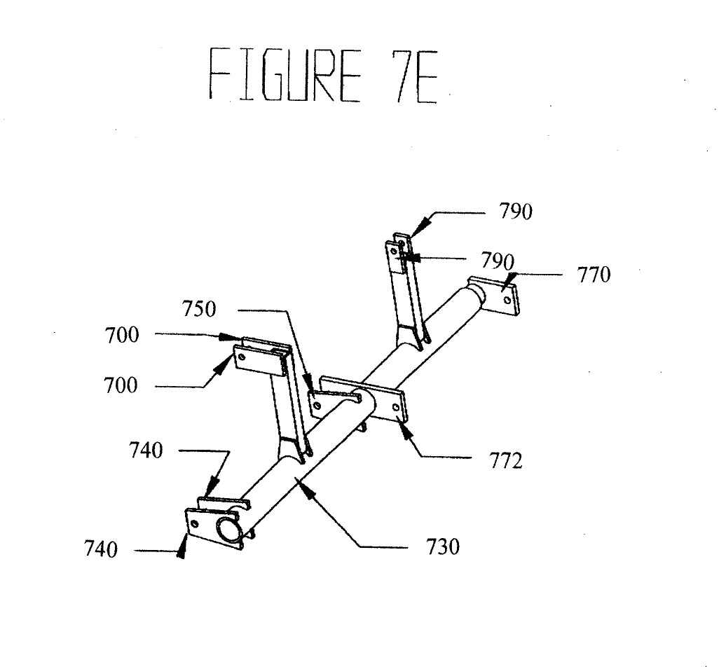

FIG. 7, Panels A-E, shows an embodiment of the Shifthitch in which the hitch allows the attachment to be offset to the right of the vehicle. As seen in Panels 7A (top view), 7B (combination of front and side view), 7D (perspective from the front or from the tractor side), and 7E (combination of back and side view), the Shifthitch is comprised of tube 730 on which is attached one connection for the three point hitch and one connection for an attachment. The connection from the Shifthitch to the three point hitch occurs at connector 700 for the connection to the center arm of the three point hitch and at connectors 740 and 750 for the connections to the outer arms of the three point hitch. The connections to the attachment occur at connectors 770, 772, and 790. Panel 7C shows a side view of the embodiment in which connectors 700, 740, and 772 are shown along with tube 730. Of course, one can envision the connections reversed so the connection to the three point hitch is to the right of the connection to the attachment. This allows the attachment to be offset to the left of the vehicle. One can also envision a Shifthitch that provides more than one connection to an attachment, thereby allowing multiple attachments to be connected. The various views of the Shifthitch are provided to give the reader a better understanding of the elements of the hitch as provided in this embodiment.

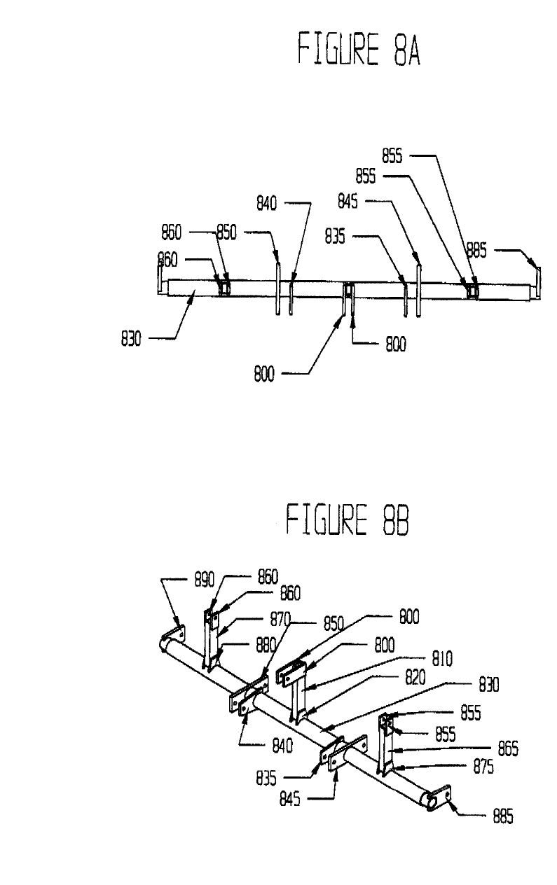

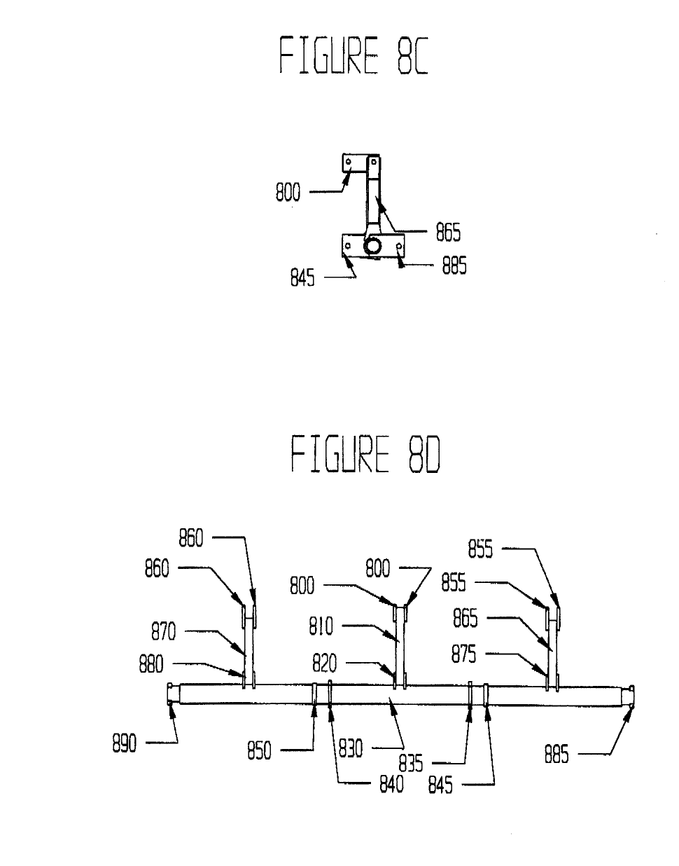

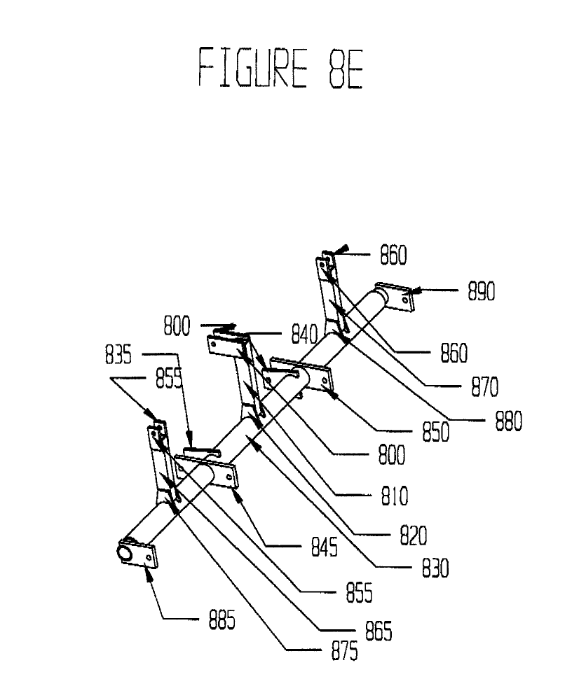

In addition to the Swinghitch and Shifthitch, the present invention provides another configuration of the apparatus, which is referred to herein as a “Dualhitch”. Like the other configurations, the Dualhitch is an adaptor for a hitch of a motor vehicle, such as a tractor. Like embodiments of the Shifthitch, the Dualhitch allows at least two attachments to be connected to the tractor at the same time. FIG. 8, Panels A-E, shows one embodiment of the apparatus in which two attachments can be connected to the Dualhitch. Panel 8A depicts a top view of the Dualhitch in which connectors 800, 835, 840, 845, 850, 855, 860, and 885 are attached to tube 830. Panels 8B (combination front and side view), 8D (front view or perspective from the tractor), and 8E (combination back and side view) show the embodiment in more detail. These views show a tube 830 on which is attached an appendage (connectors 800, 810, and 820) that can be attached to a three point hitch and two appendages (connectors 855, 865, 875, and 860, 870, 880) that can be connected to attachments. The Dualhitch and the three point hitch are connected at three points. The center arm of the three point hitch is attached to connector 800 of the Dualhitch and the outer arms of the three point hitch are attached to connectors 835 and 840 of the Dualhitch. One attachment can be connected at connectors 845, 855, and 885 of the Dualhitch and the other attachment can be connected at connectors 850, 860, and 890 of the Dualhitch. Panel 8C depicts a side view of the apparatus in which connectors 800, 845, 865, and 885 are shown. As with other embodiments, multiple views are provided in FIG. 8 to give the reader a better understanding of the elements and their relationship to each other.

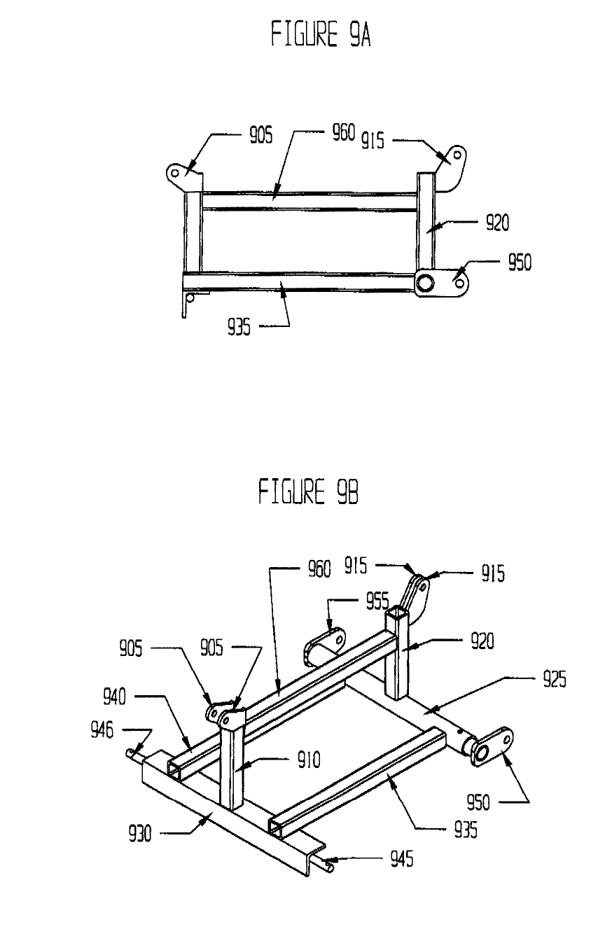

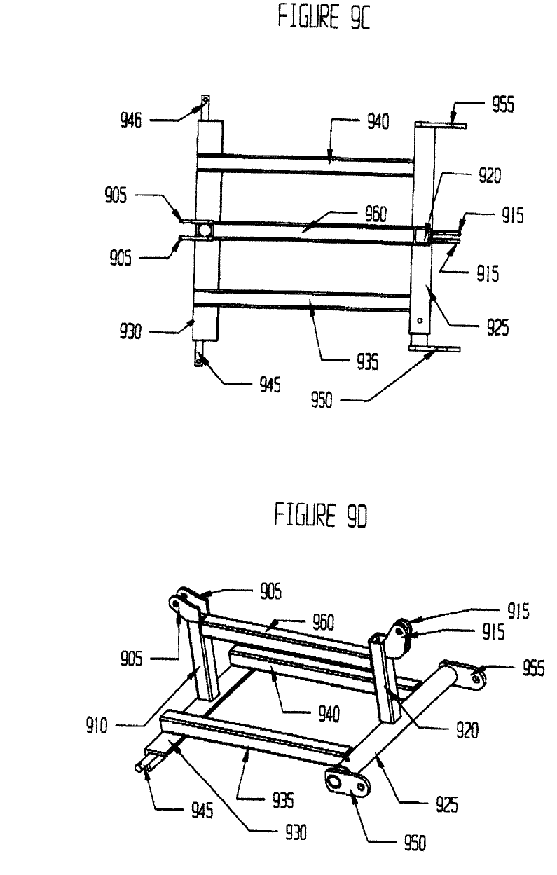

In yet a further configuration of the apparatus of the invention, the apparatus is referred to as an “Extendhitch”, which adds an extension between a motor vehicle (e.g., tractor) and the apparatus. The Extendhitch allows the attachment to be located farther back from the tractor. FIG. 9, Panels A-D, show one embodiment of the Extendhitch. Panel A, a side view, depicts connectors 905, 915, 935, 950, and 960 and tube 920. More detail can be seen in Panels B and D (combination of top and side views) and Panel C (perspective from the top). Connectors 905, which are attached to tube 910 (hidden in Panel 9C) of the Extendhitch, can be linked to the center arm of a three point hitch. In addition, dowels 945 and 946 (hidden in Panel 9D) can be attached to the outer arms of a three point hitch. Connectors 935, 940, and 960 can vary in length and connect bracket, brace, or support 930 to tube 925 and tube 910 to tube 920. The attachment of interest can be connected to the Extendhitch at connectors 915, 950, and/or 955. Bracket 930 can be welded to connectors 935 and 940, and to tube 910. Some of the advantages of the Extendhitch can be described using the example of a grader blade attachment. Without the Extendhitch, the grader blade is located relatively close to the vehicle, which can limit the smoothing of the path being graded. That is, location of the blade close to the tractor allows for significant transmission of movements, such as vertical vibrations, from the tractor to the blade. Also, the closeness of the blade to the tractor limits the effective weight of the blade by transferring some of the weight to the tractor, which is transmitted to the earth via the tires. The limited effective weight of the grader blade can limit the amount the blade can cut into the soil, reducing its efficiency. With the Extendhitch adapter between the vehicle and the grader blade attachment, the increased distance between the attachment and the vehicle allows smoother grading because the blade acts more independently from the tractor. For example, with the blade farther away from the tractor, the blade is not jostled as much when the tractor goes over a bump in the road. The increased distance between the blade and the tractor also gives greater effective weight to the blade so it will dig better during use. The Extendhitch may extend the distance between the attachment and the vehicle from about one foot to about 50 feet. In a preferred embodiment, the Extendhitch extends the distance between the attachment and the vehicle by about 2 feet to about 5 feet.

Additional weight can be added to any of the universal adapters to aid in traction and allow an attachment to function better. The weight can be added as suitcase weights which comprise slots that can hang over a vertical bar attached to a universal adapter, for example. The weight can also be bolted the sides of an adapter, a bracket can be added to an adapter to suit a specific weight, or the weight can be added in any way that would allow weight to be attached or placed on the adapter. In the case of the Extendhitch, weight can be added directly to the tray of the Extendhitch. The weight can be in the form of suitcase blocks, concrete blocks, bolt on weights, weld on weights or any other way that would add weight to an adapter.

In some embodiments, the present invention provides for a combination of at least two of the universal adaptor configurations described above. The combination may comprise at least any two of the different adaptors or a combination of similar and different adaptors. Because the adapters can be connected in series, there are many combinations of adapters that can be envisioned. Therefore, for example, the Swinghitch can be connected to a three point hitch of a vehicle, and a Dualhitch can be connected to the Swinghitch to form an apparatus that can pivot and connect two different attachments. In another example, the Shifthitch and Extendhitch can be combined to form an apparatus that is shifted to the side of the vehicle and has an attachment connected farther away from the vehicle. In still another example, two Extendhitch apparatuses can be connected so that the attachment will be twice as far back from the vehicle as compared to employing only one Extendhitch. Additionally, a Swinghitch can be connected to a three point hitch of a vehicle, an Extendhitch can be connected to the Swinghitch, and a Dualhitch can be connected to the Extendhitch to form an apparatus that can pivot, allows two attachments to be connected and is farther away from the vehicle. It should be evident that any number of combinations are possible, and can be created to suite a user's needs.

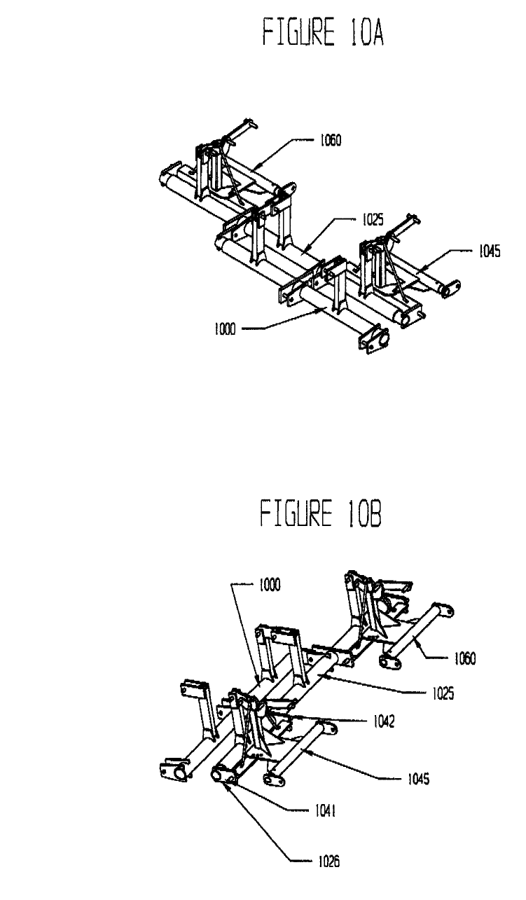

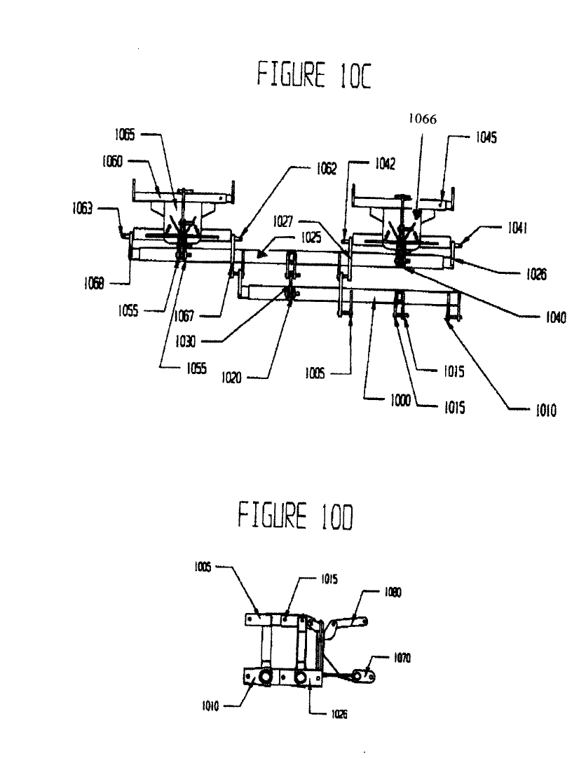

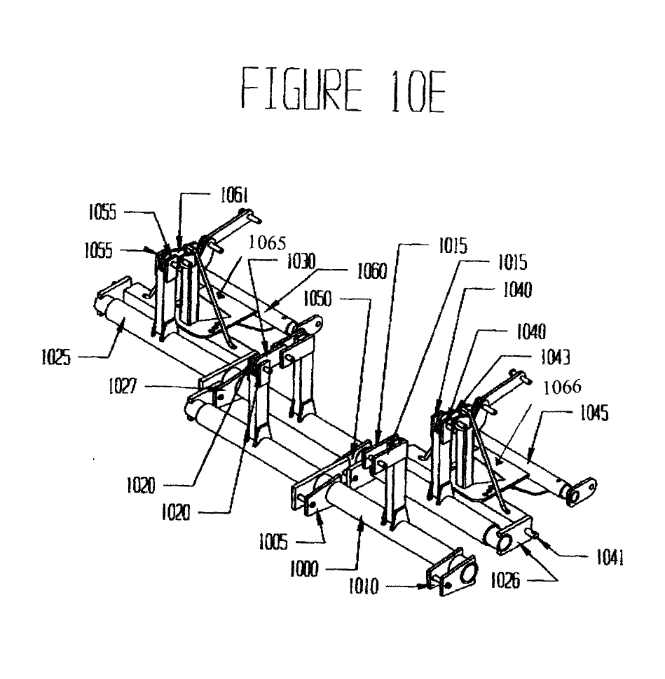

An example of a combination adaptor according to the invention is shown in FIG. 10, Panels A-E. As shown, a Shifthitch can be connected to a three point hitch, a Dualhitch can be connected to the Shifthitch, and two Swinghitches can be connected to the Dualhitch. Panel 10A (combination of front and side view) points out the main rods of the apparatus. Rod 1000 comprises the Shifthitch, rod 1025 is part of the Dualhitch, and rods 1045 and 1060 comprise the two Swinghitches of the apparatus. Panel 10B (combination of back and side view) additionally shows connector 1026 and dowels 1041 and 1042. Panels 10C (top view) and 10E (combination front and side view) show the Shifthitch in yet more detail. Specifically, the Shifthitch comprising a rod 1000 can be attached to a three point hitch at connectors 1005, 1010, and 1015 (three point hitch not shown). The Dualhitch comprising a rod 1025 is attached to the Shifthitch at connectors 1020, 1026, 1027, and 1050 of the Shifthitch and connectors 1025 and 1030 of the Dualhitch. One Swinghitch comprising a rod 1045 and platform 1066 is attached to a Dualhitch by way of connectors 1041, 1042 (hidden in Panel 10E), and 1043 (hidden in Panel 10C) on the Swinghitch to corresponding connectors 1026, 1027, and 1040 of the Dualhitch. Another Swinghitch comprising a rod 1060 and platform 1065 is attached to a Dualhitch by way of connectors 1062 (hidden in Panel 10E), 1063 (hidden in Panel 10E), and 1061 (hidden in Panel 10C) on the Swinghitch to corresponding connectors 1067, 1068, and 1055 of the Dualhitch. Panel 10D depicts a side view of the Shifthitch in which connectors 1005, 1010, and 1015 can be seen. Connectors 1070 and 1080 connect to an attachment.

The combinations specifically described are only examples and should not limit the present invention. One can envision many permutations that can be employed using combinations of the Swinghitch, Shifthitch, Extendhitch, and Dualhitch. In preferred embodiments, the combinations comprise a single Swinghitch. It is to be noted that various advantages of combinations can be achieved, depending on the types of adaptors present. One advantage achieved by combinations that allow for connection of two or more attachments is cost savings. That is, the cost of attachments is not linearly proportional to the size of the attachment, but instead increases at a rate more than linear. For example, a plow blade of a given size might cost $500, whereas a plow blade twice that size might cost $3,000, not $1,000. Through use of a combination adaptor of the invention (or any adaptor allowing for multiple attachments), a user can save significant amounts of money by purchasing multiple relatively small attachments and using them in tandem, rather than purchasing one large attachment. Cost savings can also be achieved when repairs or replacement parts are required. For example, rather than completely losing use of an attachment if repairs are needed, the system of the invention permits repair of one attachment while continuing use of the other. Furthermore, when an attachment needs replacing, a single relatively small (and less expensive) attachment can be replaced rather than having to replace a large, expensive attachment.

In a further aspect of the invention, the present invention provides a method of employing at least one of the universal adapters of the invention. In general, the method comprises providing one or more of the adapters described as the invention, connecting at least one adapter to a vehicle via a three point hitch or similar system, and connecting at least one attachment to the adaptor. In many embodiments, the methods comprise using at least one attachment that is connected to the adaptor(s) for its function.

According to the method, employing the adaptor(s) means using the adaptor(s) for any suitable activity. Typically, employing will mean using the adaptor(s) to connect one or more attachments or implements to a motor vehicle. Furthermore, typically, the connection will be by way of a hitch, such as a three point hitch, that comprises part of the motor vehicle. It is not important whether the adaptor is first connected to the hitch or the attachment. Connection sequence will be left to the choice of the practitioner, and will usually be dependent on the size of the attachment, the ease of movement of the attachment, and the accessibility of the attachment and motor vehicle. Mechanical assistance can be used in the attachment process.

According to the method, one or more adaptors are provided. In this context, providing means any action that results in one or more adaptors being present and available for connection to a hitch, an attachment, or both.

The method may comprise connection of one or more different adapters to the hitch, connection of one or more of the same adapters, or a combination thereof. Therefore, the methods comprise providing at least one Swinghitch, Shifthitch, Dualhitch, and/or Extendhitch adapter, connecting at least one of these adapters to a vehicle via a hitch system, connecting at least one attachment to the adaptor(s), and optionally using at least one attachment for its function. The method may comprise connecting one or more of the same adapters, such as several Extendhitch adapters, to each other to increase the distance between the vehicle and the attachment. The method may comprise using combinations of the adapters, such as using a Shifthitch and a Swinghitch to allow the attachment to be offset to the vehicle as well as allow it to pivot relative to the vehicle. This method may be used for many different combinations of the universal adapters and is not limited to examples described herein. As mentioned above, the sequence of connections is not important.

It will be apparent to those skilled in the art that various modifications and variations can be made in the practice of the present invention and construction of the disclosed apparatus without departing from the scope or spirit of the invention. Other embodiments of the invention will be apparent to those skilled in the art from consideration of the written description and figures, and from practice of the invention. It is intended that the written description and drawings, including the examples, be considered as exemplary only, with the true scope of the invention being set forth in the claims.

1. An apparatus that connects an attachment to a hitch system of a vehicle, said apparatus comprising:
at least one three-point hitch connector that connects the apparatus to the hitch system;
at least one three-point hitch that connects the apparatus to the attachment; and
at least one adaptor that provides at least one degree of freedom for connecting the attachment to the hitch system.

2. The apparatus of claim 1, wherein the apparatus provides at least two degrees of freedom.

3. The apparatus of claim 1, wherein the adaptor pivots to allow the attachment to be attached at an angle to the hitch system.

4. The apparatus of claim 1, wherein the adaptor provides a connection point for the attachment to the hitch system that is offset to the left or right, with respect to the front-rear axis of the vehicle, as compared to the hitch system.

5. The apparatus of claim 1, wherein the adaptor provides a connection point for the attachment to the hitch system that is a distance away from the hitch system and substantially parallel to the front-rear axis of the vehicle.

6. The apparatus of claim 1, wherein the adaptor provides two or more connection points for attachments to the hitch system.

7. The apparatus of claim 1, comprising: at least one three-point hitch connector that connects the apparatus to the hitch system;
at least one three-point hitch that connects the apparatus to the attachment; and
at least one adaptor that provides at least one degree of freedom for connecting the attachment to the hitch system, wherein the adaptor comprises two or more of:
an adaptor that pivots to allow the attachment to be attached at an angle to the hitch system,
an adaptor that provides a connection point for the attachment to the hitch system that is offset to the left or right, with respect to the front-rear axis of the vehicle, as compared to the hitch system,
an adaptor that provides a connection point for the attachment to the hitch system that is a distance away from the hitch system and substantially parallel to the front-rear axis of the vehicle, and
an adaptor that provides two or more connection points for attachments to the hitch system.

8. An apparatus that connects an attachment to a hitch system of a vehicle, said apparatus comprising:
at least one three-point hitch connector that connects the apparatus to the hitch system; and
at least one three-point hitch that connects the apparatus to the attachment;
wherein the apparatus does not comprise any wheels that contact the earth when connecting the attachment to the hitch system; and
wherein at least a portion of the apparatus can pivot relative to the hitch system.

9. The apparatus of claim 8, wherein the apparatus or a portion of it pivots at an angle along a line that is normal to the front-rear axis of the vehicle.

10. (canceled)

11. The apparatus of claim 8, wherein the apparatus can be locked at a pre-selected angle.

12. (canceled)

13. The apparatus of claim 8, wherein at least a portion of the apparatus can pivot to allow the attachment to extend outside of the width defined by the vehicle.

14. An apparatus that connects an attachment to a hitch system of a vehicle, said apparatus comprising:
at least one three-point hitch connector that connects the apparatus to the hitch system; and
at least one three-point hitch that connects the apparatus to the attachment;
wherein the apparatus does not comprise any wheels that contact the earth when connecting the attachment to the hitch system; and
wherein the three-point hitch that connects the apparatus to the attachment comprises at least one point of connection that is offset to a side of the hitch system, relative to the font-to-rear axis of the vehicle.

15. The apparatus of claim 14, wherein the three-point hitch that connects the apparatus to the attachment offsets the attachment to the side of the vehicle from 0.5 feet to 10 feet.

16. An apparatus that connects an attachment to a hitch system of a vehicle, said apparatus comprising:
at least one three-point hitch connector that connects the apparatus to the hitch system; and
at least one three-point hitch that connects the apparatus to the attachment;
wherein the apparatus does not comprise any wheels that contact the earth when connecting the attachment to the hitch system; and
wherein the three-point hitch that connects the apparatus to the attachment comprises at least one point of connection that is extended a distance behind or ahead of the hitch system connection.

17. The apparatus of claim 16, wherein the three-point hitch that connects the apparatus to the attachment extends the connection point to the hitch system from one foot to fifty feet back from the vehicle.

18. An apparatus that connects an attachment to a hitch system of a vehicle, said apparatus comprising:
at least one three-point hitch connector that connects the apparatus to the hitch system; and
at least one three-point hitch that connects the apparatus to the attachment;
wherein the apparatus does not comprise any wheels that contact the earth when connecting the attachment to the hitch system; and
wherein the at least one three-point hitch that connects the apparatus to the attachment comprises at least two points of connection for at least two attachments.

19. The apparatus of claim 18, wherein the at least one three-point hitch that connects the apparatus to the attachment comprises two points of attachment for the attachment to the apparatus.

20. The apparatus of claim 18, wherein at least one of the points of attachment is offset to a side of the hitch system, relative to the font-to-rear axis of the vehicle.
